(19) United States
(12) Patent Application Publication
(10) Pub. No.: US 2019/0118355 A1
(43) Pub. Date: Apr. 25, 2019

(54) Check For Use On Bladed Machines

(71) Applicant: Michael O'Neil, Lowell, IN (US)

(72) Inventor: Michael O'Neil, Lowell, IN (US)

(21) Appl. No.: 16/148,130

(22) Filed: Oct. 1, 2018

Related U.S. Application Data
(60) Provisional application No. 62/574,920, filed on Oct. 20, 2017.

(51) Int. Cl. B25B 23/00; B25B 13/58

(52) U.S. Cl. CPC B25B 23/0085; A01D 34/412; B25B 13/58

(57) ABSTRACT

A tool to be used when tightening or loosening a bolt that secures a blade, a lawnmower blade for example, to a machine. The tool checks the movement of the blade that occurs when the bolt is being loosened or tightened.

### CROSS-REFERENCE TO RELATED APPLICATIONS

The present application claims the benefit of U.S. Provisional Patent Application No. 62/574,920, filed Oct. 20, 2017, the entirety of which is hereby incorporated by reference.

### BACKGROUND

Manufacturers in the United States ship an estimated nineteen billion dollars of farm machinery every year. Much of that machinery uses cutting blades. Commonly, such blades are attached, using a bolt, to a motor that spins which causes the blade to cut what comes in its path. Such blades are often used on lawn mowers.

Because the blade is firmly attached to some spinning mechanism, such as a gas powered motor, it is difficult to remove the bolt that attaches the blade to the motor. The blade merely spins with the bolt. There is a need to prevent the blade from spinning when loosening or tightening the bolt that attaches the blade to the motor. People have attempted solutions that are dangerous such as jamming pieces of metal or wood into the space where the blade spins, or attempting to fasten the blade to the housing of the lawnmower. The methods attempted do not work easily and safely to remove a blade from machinery, from a lawnmower for instance.

For the foregoing reason, there is a need in the industry for an apparatus that is easy to use, inexpensive, and assists humans in removing or replacing a machine's blade, a lawnmower blade to name one example.

### SUMMARY

The present invention is directed to an apparatus that satisfies this need. The apparatus comprises an attachment where a person can connect a ratchet, or some other grasping tool. A span of a strong material, steel for instance, to which the attachment is connected. The span has at each end stems extending somewhat perpendicular to the axis of the span. The stems can be covered with a protective material, plastic for instance. The stems have a flange attached to their other end. The flange is parallel to the axis of the span. There is an open space between flanges that allows placement of a workpiece, such as a lawnmower blade.

An embodiment of the check is used to grab onto a blade which is attached to a motor via a bolt. The check allows the bolt to be loosened or tightened by checking the blade and keeping it from moving. The inventive apparatus prevents injury to machine and man that might occur from improper propping or securing of a sharp blade during removal.

Another embodiment of the inventive apparatus for manipulating a lawnmower blade is made up of a check which has a bar, usually longer than it is wide. There are a plurality of stops. The stops are made of a durable material so that they can withstand being pressed up against a lawnmower blade with great force.

The plurality of stops are oblong, though it is envisioned that many shapes will serve the purpose of the stops. The plurality of stops are oriented such that their longitudinal axes are perpendicular to the longitudinal axis of the bar. In that way, one stop and the bar form the shape of an L. First ends of the plurality of stops being attached to the bar, the first ends are the ends that are closest to the bar, proximal. Then the plurality of stops extend away from the bar, all stops doing so in the same direction, essentially.

The plurality of stops have an end that is distal to the bar where there are attached a plurality of rests. The rests each have a resting surface. The plane of the resting surfaces are parallel to the longitudinal axis of the bar.

Yet another embodiment of the invention has the check with its plurality of rests being covered with a protective material. In one embodiment the inventor used plastic sleeves that wrapped the rests. This protects a workpiece from being damaged by the stops when a user is exerting pressure on the check to remove a lawnmower blade.

Another embodiment of the present invention has a check with a space, a cavity, existing between the bar and the plurality of rests. The cavity width being such that a lawnmower blade can be inserted therein, for example and being, several times the thickness of a lawnmower blade.

It is envisioned that a grip can be used on any embodiment of the present invention. It is fixedly attached to the bar. Envisioned is a bolt like nib that can be grasped with a hand tool, or even a nib or mound with a hole for inserting the end of a ratchet shaft. The inventor envisions this being where a tool can be attached to grasp and turn the check and can take any number of forms and shapes well known to mechanics.

Interestingly, the check allows for inserting twisted lawnmower blades easily into the cavity. Any embodiment of the check will provide increased leverage when it is moved away from the center of a workpiece the check is acting upon. They can be used without causing damage to a lawnmower blade, attached to a common hand tool to provide torque, and can safely hang from a lawnmower blade by placing the resting surfaces against the lawnmower blade which frees an operator's hands during use of the check.

Additionally, any embodiment of the check can be used for both tightening or loosening a machine's blade and be made from a durable hard material such as metal or the like. The inventor envisions a check being made by a roll molding process. Furthermore, any embodiment of the check is capable of withstanding extreme torques.

The inventor has found the usefulness of his invention to be that any embodiment of the check is intended to be used on a lawnmower blade to grasp the blade and hold the blade in place while rotating the center nut that fastens the blade to a lawnmower engine.

### BRIEF DESCRIPTION OF THE SEVERAL VIEWS OF THE DRAWINGS

These and other features, aspects and advantages of the present invention will become better understood with regard to the following description, appended claims, and accompanying drawing where:

FIG. 1 shows a perspective view of an embodiment of the check according to the present invention.

FIG. 2 shows a perspective view of another embodiment of the check according to the present invention.

FIG. 3 shows a perspective view of another embodiment of the check according to the present invention being used on a lawnmower blade.

### DESCRIPTION

### Overview.

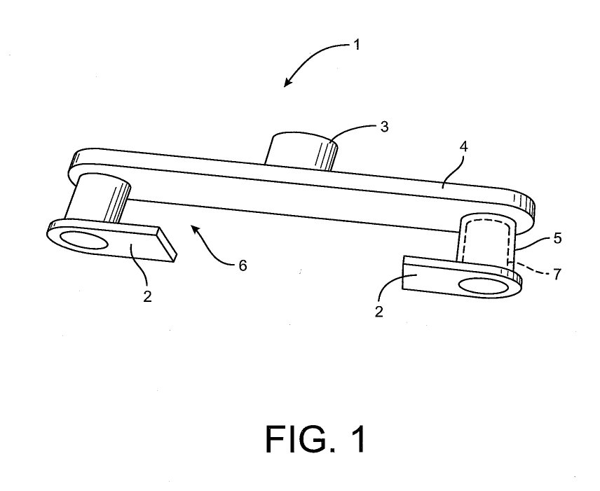

As shown in FIG. 1, an embodiment of the check 1 according to the present invention comprises a pair of rests 2, a grasp 3, a bar 4, a pair of stops 7 covered with a protective material, in this case plastic sleeves 5. The rests 2 being each connected to a separate stop 7. The stops 7 being covered by the protective material 5. The grasp 3 being integrally connected to the bar 4. At each end of the bar 4 is connected a stop 7. There being a cavity 6 between the bar 4 and the rests 2 sufficient to allow fitting a workpiece, such as a lawnmower blade. The check 1 being made from a durable material, found to be best is metal.

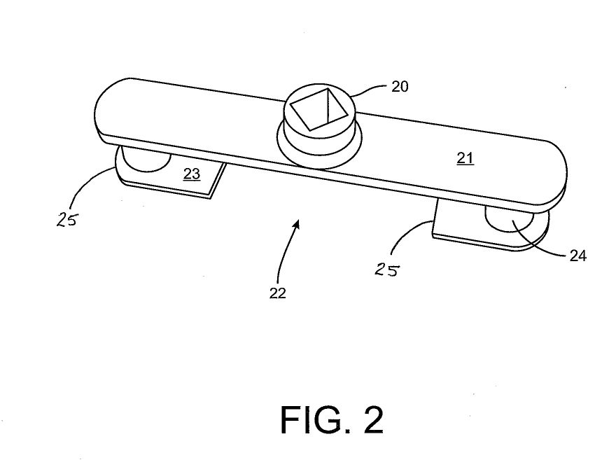

As shown in FIG. 2, another embodiment of the check according to the present invention comprises a grasp 20 that accommodates a ratchet shaft (not shown). A pair of protected stops 24 are attached to each end of a bar 21. Each of the stops has a resting surface 23 that is part of a rest 25. The rests 25 being attached to the stop 24 at the end opposite where the stop 24 connects to the bar 21. The cavity 22 between stops 24 and the bar 21 allows for placement of a lawnmower blade of any size commonly used.

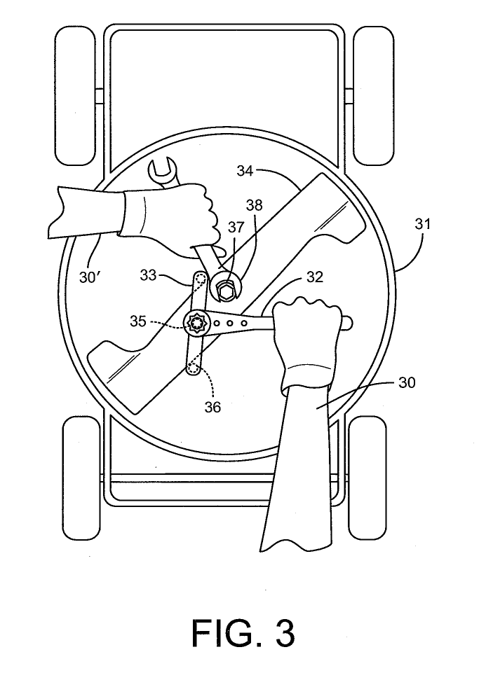

As shown in FIG. 3, another embodiment of the check according to the present invention being used on a lawnmower blade comprises a person 30. The person 30 having a first ratchet wrench 32 in one hand. That first ratchet wrench 32 is removably attached to the check at the grasp 35. The check 33 is hanging on a lawnmower blade 34 which is attached to a lawnmower 31 via a bolt 37. The blade 34 moves when the person 30′ twists the bolt 37 to remove the blade 34 from the mower 31. The blade 34 is checked in its movement when it contacts the check 33 at the stops 36 and the person 30, by using the wrench 38, causes the check 33 at its stops 36 to exert force against the blade and prevent further movement of the blade 34 thus allowing the person 30 to remove the bolt 37.

Although the present invention has been described in considerable detail with the reference to certain preferred versions thereof, other versions are possible. For example, there could exist stops that are attached at points other than the ends of the bar, the stops could be symmetrically shaped instead of oblong, or the check could be made of a durable plastic material. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. § 112, ¶6.

What I claim is:

1. An apparatus for manipulating a lawnmower blade, the apparatus comprising:
a check;
the check having a bar;
a plurality of stops;
the plurality of stops being oblong;
the plurality of stops being oriented with their longitudinal axes perpendicular to a longitudinal axis of the bar;
first ends of the plurality of stops being attached to the bar;
the plurality of stops extending away from the bar in substantially the same direction;
the plurality of stops having an end that is distal to the bar;
a plurality of rests;
the plurality of rests having a resting surface;
the plurality of rests being attached to the stops at the end that is distal to the bar;
a plane of the resting surface being parallel to the longitudinal axis of the bar.

2. The check of claim 1 wherein the plurality of rests are covered in a protective material.

3. The check of claim 1 further comprising:
a cavity formed between the bar and the plurality of rests;
the cavity having a width that is several times the thickness of a lawnmower blade.

4. The check of claim 1, 2 or 3 further comprising:
a grip;
the grip being fixedly attached to the bar.

5. The check of claim 1 wherein the twisted lawnmower blades are easily insertable into the cavity.

6. The check of claim 1 wherein the check is capable of providing increased leverage as it is moved away from the center of a workpiece the check is acting upon.

7. The check of claim 1 wherein the check can be used without causing damage to a lawnmower blade on which the check is working.

8. The check of claim 1 wherein the check can be attached to a common hand tool.

9. The check of claim 1 wherein the check can safely hang from a lawnmower blade by placing the resting surfaces against the lawnmower blade which frees an operator's hands during use of the check.

10. The check of claim 1 wherein the check can be used for both tightening or loosening a lawnmower blade.

11. The check of claim 1 wherein the check is made from metal.

12. The check of claim 1 wherein the check is manufactured by a roll molding process.

13. The check of claim 1 wherein the check is capable of withstanding extreme torques.

14. The check of claim 1 wherein the check is intended to be used on a lawnmower blade to grasp the blade and hold the blade in place while rotating the center nut that fastens the blade to a lawnmower engine.
